(19) United States
(12) Patent Application Publication
(10) Pub. No.: US 2008/0168977 A1
(43) Pub. Date: Jul. 17, 2008

(54) Portable Charcoal Grill With Incorporated Fan

(76) Inventor: Farid Daud, Haifa (IL)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 12/046,974

(22) Filed: Mar. 12, 2008

(30) Foreign Application Priority Data
Sep. 12, 2005 (IL) 170823
Jul. 12, 2006 (IL) PCT/IL06/00805

(51) Int. Cl. A47J 37/07; F24B 1/185

(52) U.S. Cl. 126/25 B; 126/15 A

(57) ABSTRACT

A charcoal grill (10) providing a rapid ignition and heating of the charcoal, by means of an electric fan (30) that is coupled to the body (12) of the grill. The fan decreases the overall time required to heat the charcoal to proper cooking temperature by increasing the flow of air provided to the charcoal. The increased airflow created by the incorporated fan accelerates the firing-up and heating of the charcoal by channeling air across and through the charcoal. The decreased time required to heat the charcoal to a temperature suitable for cooking, further more ensures more efficient use of the charcoal.

### CROSS-REFERENCE TO RELATED APPLICATIONS

This patent application is a continuation-in-part of PCT Patent Application No. PCT/IL06/00805, filed Jul. 12, 2006, which is based upon and claims the benefit of Israel Patent Application No. 170823, filed Sep. 12, 2005 entitled “Portable Charcoal Grill with Incorporated Fan,” both of which are incorporated herein by reference.

### FIELD OF INVENTION

This invention relates generally to charcoal grills, and specifically to such devices that also have incorporated electric fans.

### BACKGROUND OF THE INVENTION

Barbequing over charcoal grills is enormously popular the world over. To that end, consumers are able to choose from a seemingly endless array of charcoal grills that come in all shapes and sizes. In spite of great availability of charcoal grills and in spite of the bells and whistles that may accompany them, these grills universally face one great set back. Charcoal grills require approximately 30 minutes or more to heat the charcoal to a temperature suitable for safe and effective cooking.

Accelerants, like lighter fluid, may be used to decrease the igniting and heating time. However, such additives emit noxious fumes that contribute to ozone pollution. Because toxic chemicals may also enter the food and affect the flavor, one must take additional care to ensure that the additives are fully burned off before placing food on the grill.

Chimney starters are another option for decreasing charcoal heating time, wherein the charcoal is heated in a separate container and when sufficiently heated, is poured into the grill's cook box.

A safer and more practical option is to employ a fan. Traditionally, the tiring method of waving any available planar object, such as sheets of paper or a paper plate, is used. Using an electric fan is much less strenuous. Illustrative of such fans include U.S. Pat. No. 6,571,788 and German Patent 4423862, which disclose hand-held electric fans; German Patent 1245710, which discloses a fan that attaches to the bottom of a grill; U.S. Pat. No. 6,615,820, which discloses a fan through which air is blown from the upper side of the grill; and U.S. Pat. No. 3,933,145, which discloses a fan that is incorporated into the hood of a grill.

However, such devices, for reasons that will become apparent, do not provide a simple and easy to use device that generates an airflow that travels through the charcoals, allowing accelerated ignition and heating of the charcoal without creating potential contaminants or blowing ashes into the cooking food, in accordance with the principle of the present invention.

### SUMMARY OF INVENTION

Presented herein is a portable charcoal grill with the added advantage of providing rapid ignition and heating of the charcoal, by means of an electric fan that is coupled to the body of the grill. The fan decreases the overall time required to heat the charcoal to proper cooking temperature by increasing the flow of air to the charcoal.

In accordance with exemplary embodiments of the present invention, the increased airflow created by the incorporated fan aids in heating and firing up the charcoal by channeling air up through the charcoal.

Because the fan blows the air into the cooking box below the level of the charcoal, thereby effectively providing additional air for the fire, while allowing the air to circulate naturally and uniformly up through the charcoal, ashes and charcoal dust are not blown up into the air or onto the food.

The decreased time required to heat the charcoal to a temperature suitable for cooking that results from the use of the present invention furthermore ensures more efficient use of the charcoal.

Another novel feature of some embodiments of the present invention is that charcoal can be placed on the entire surface of the cooking grid, without concern for providing entry for oxygen. This is because an attached air chamber allows air to enter from below the charcoal plate and flow up through the charcoals.

Yet another useful feature offered by the present invention relates to a protective screen that prevents charcoal and ashes from escaping from the grill area, onto the fan.

An additional unique feature disclosed in the present invention is providing an add-on air chamber that is incorporated within the grill box. The ability to disassemble the air chamber of the grill provides a new portability option and diversity to the charcoal grill.

### BRIEF DESCRIPTION OF DRAWINGS

These and further features and advantages of the invention will become more clearly understood in light of the ensuing description of a preferred embodiment thereof, given by way of example only, with reference to the accompanying drawings, wherein—

FIG. 1 is a perspective view of an exemplary embodiment of the present invention;

FIG. 2 is a perspective view of the same embodiment, with the fan door open;

FIG. 3 is an exploded view of the same embodiment;

FIG. 4 is a cross-sectional view of an exemplary embodiment of the present invention with the ash catcher open;

FIG. 5 describes the- direction of airflow into and through the grill of the present invention;

FIG. 6 describes the direction of airflow through and out of the grill of the present invention.

FIGS. 7a, b, and c illustrate two isometric views of an add-on air chamber in accordance with a preferred embodiment of the present invention as well as a cross sectional view of the air chamber.

FIG. 8 illustrates a grill partially installed with the add-on air chamber shown in FIG. 7.

FIG. 9 illustrates a grill provided with the add-on air chamber in accordance with another preferred embodiment of the present invention.

### DESCRIPTION OF THE PREFERRED EMBODIMENT

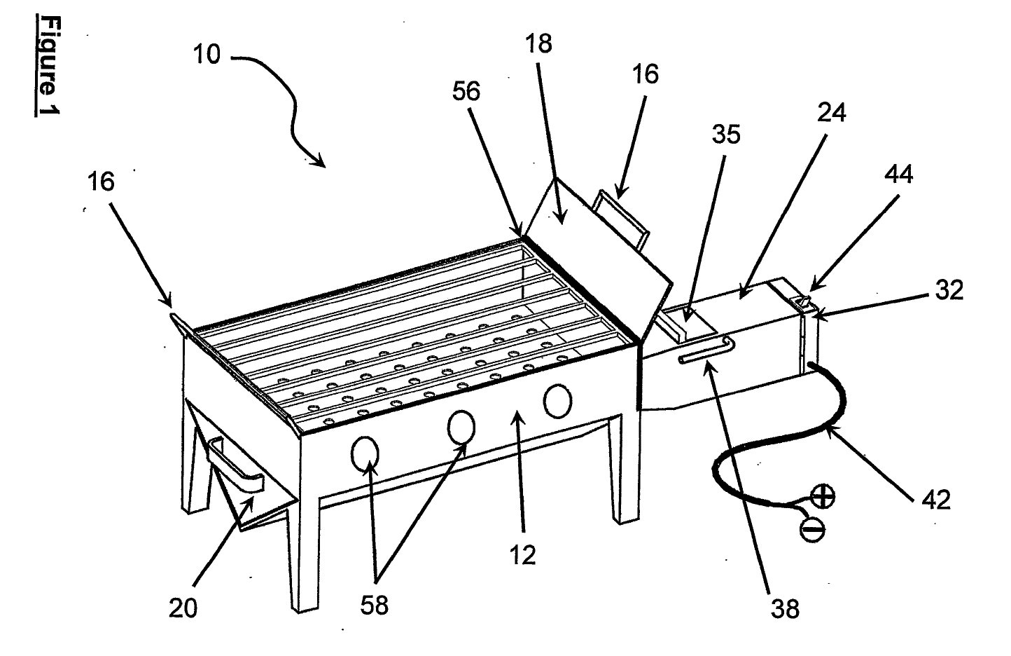

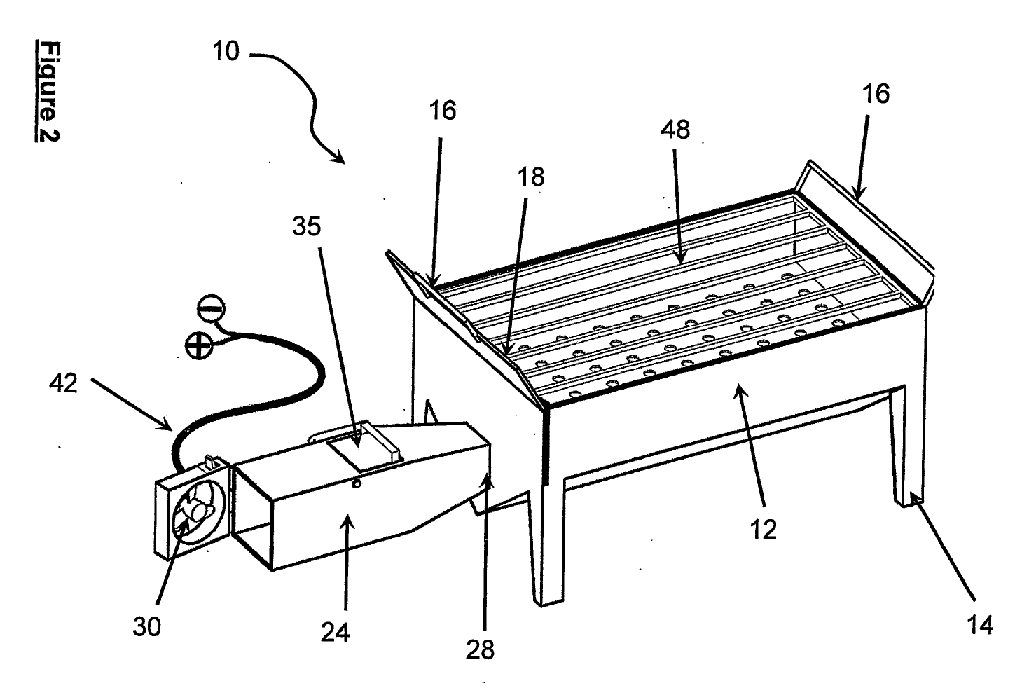

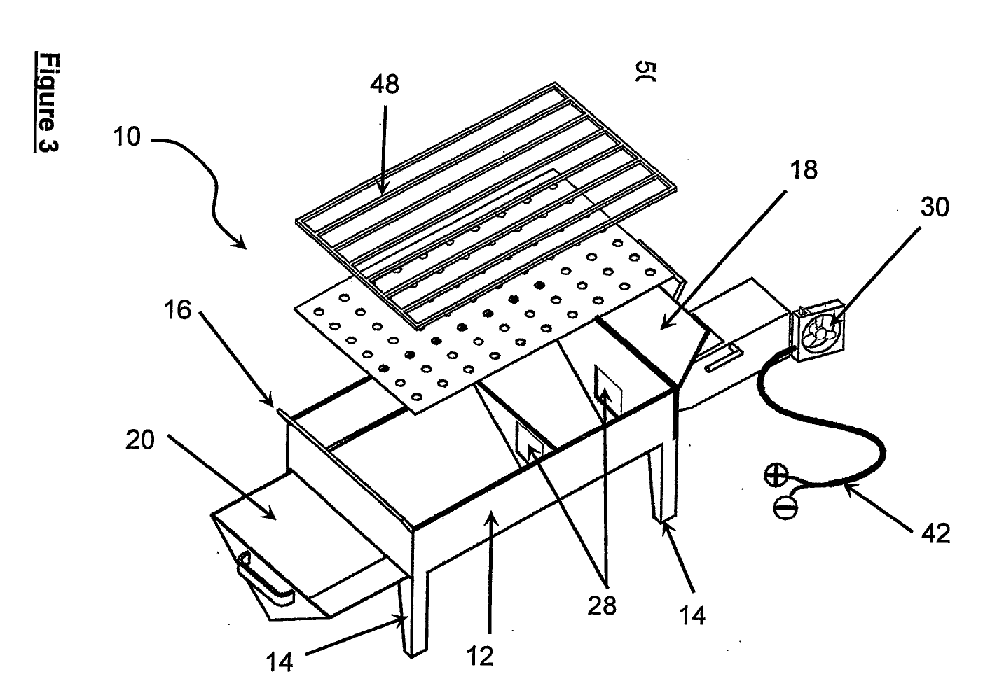

The description presented here relates to an exemplary embodiment of the present invention as shown in FIGS. 1, 2, and 3, wherein a grill 10 substantially comprises a grill body 12 that houses the cooking components of the invention, an air chamber 24 that is attached at one end to body 12, and an electric fan 30 that is set into the second end of air chamber 24. When fan 30 of portable grill 10 is in the “ON” position, -the airflow generated by fan 30 causes the charcoal to heat more quickly and efficiently by providing additional oxygen to feed the flames.

Portable grill 10 can be used repeatedly and the components are made of any durable, heat-resistant materials that will stand up to repeated use.

Grill body 12 is the cook box that houses the cooking components of portable grill 10. In an exemplary embodiment, grill body 12 is of a rectangular box shape. Other embodiments may have other shapes, for example, a square or circular container. In accordance with some embodiments of the present invention, there may be openings 58 scattered across the lateral surfaces of grill body 12, an aesthetic feature that allows the flames to be viewed, a feature seen in FIG. 1.

In some embodiments of the present invention, grill body 12 is constructed as two parts, an upper part and a lower part. In such embodiments, the upper part of grill body 12 may be separable from the lower part of grill body 12 and replaced. Preferably, the upper part includes grill plate 50.

Portable grill 10 may be equipped with at least three legs 14 that extend down from grill body 12. These legs 14 serve to provide added stability when grill 10 sits on the ground. Legs 14 may be rigidly affixed to grill body 12 and positioned on grill body 12 in any configuration that will allow grill 10 to rest soundly on a surface. There is the option of encasing one or all of legs 14 with rubber or other heat resistant material for increased handling comfort.

A pair of carry handles 16 allows the user to transport easily portable grill 10 from one location to another. In the exemplary embodiment, carry handles 16 are rigidly affixed to grill body 12, on opposing short sides of grill body 12. In alternative embodiments, carry handles 16 may be attached elsewhere in grill 10. Furthermore, in alternative embodiments, carry handles 16 may be flexibly attached to grill body 12. Carry handles 16 are heatproof and there is the option of encasing one or both carry handles 16 with rubber or other heat resistant material for increased handling comfort.

A protective screen 18 ensures that charcoal and ashes from portable grill 10 may not reach the area of fan 30 and also prevents the heat generated by portable grill 10 from adversely affecting the user while operating fan 30, lever 38, and heat vent 34. In the exemplary embodiment, protective screen 18 is securely coupled to grill body 12, between grill body 12 and air chamber 24. Protective screen 18 may be constructed from any rigid planar material.

In some embodiments of the present invention, there is also an isolation layer 56 located between grill body 12 and air chamber 24, seen in FIG. 1. Isolation layer 56 may be constructed of wool surrounded by any rigid, planar material. Isolation layer 56 prevents the transfer of heat from grill body 12 to air chamber 24, thus protecting fan 30 from heat damage, and also preventing lever 38 and heat vent cover 35 from getting too hot to be safely handled.

An ash catcher 20 provides both a convenient location to collect the ashes that accumulate during the course of using portable grill 10 and a simple disposal method. In the exemplary embodiment, ash catcher 20 is a removable drawer that is tapered at the bottom and is opened by means of a handle located on the exterior end of ash catcher 20. In other embodiments, the drawer of ash catcher 20 may have other forms, for example, a flat or rounded bottom.

In alternative embodiments, ash catcher 20 may be an integral component of grill body 12, wherein the ashes are accessed by alternative means. For example, a sliding panel or a door that is flexibly attached to grill body 12 and rotates away from grill body 12 may be located at the lowermost portion of one side of grill body 12.

An air chamber 24 provides an enclosed area through which air may flow. Air chamber 24 is fixedly attached to one side of grill body 12 and houses the airflow regulating components of portable grill 10.

An aperture 28 located at the side of grill body 12 is connecting the grill to air chamber 24, and is positioned so that the upper edge of aperture 28 is parallel to or below the level of charcoal plate 50. Air chamber 24 covers aperture 28. Aperture 28 provides the opening necessary to allow air to flow between grill body 12 and air chamber 24. There may also be a corresponding aperture 28 in ash catcher 20.

A fan 30 is positioned at the second end of air chamber 24, situated such that when the blades rotate and create an airflow, said air flows into grill body 12. Fan 30 is comprised of a plurality of blades that extend from a central base and an electrical motor that is attached to the base to drive fan 30.

Fan 30 expedites the heating process by increasing the flow of air to the igniting charcoal. The air is then able to flow up and circulate through the charcoal to efficiently stimulate the heating process. Because fan 30 causes air to flow under the charcoal rather than down or across, there is no need to place a cover, hood, or lid over portable grill 10 when igniting and heating the charcoal.

In the exemplary embodiment, fan 30 is firmly affixed to a fan door 32, which is flexibly attached to air chamber 24 by means of a hinge or other connection device. Fan door 32 allows access to fan 30 for maintenance, repair, etc.

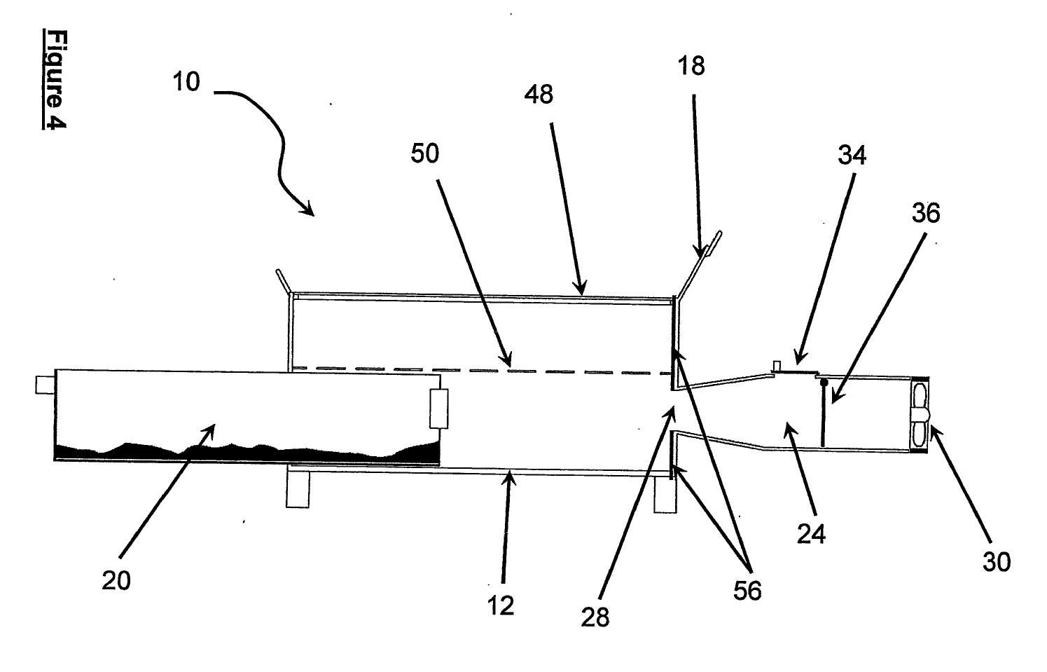

A unique feature of the present invention is an inner flap 36, which is located within air chamber 24, situated in front of fan 30. The feature can be seen in FIG. 4. Inner flap 36 is of the same shape as air chamber 24, in order to completely close off the airflow from fan 30. Inner flap 36 acts as a choke, providing the user with a means to adjust the amount of air flowing from fan 30 into grill body 12, and thereby allowing the user to control the heat of the charcoal. This feature will be useful not only during the ignition phase, but also if the user wishes, for example, to re-ignite the charcoal or control the heat of the burning charcoal.

In the exemplary embodiment, a lever 38 is used to rotate inner flap 36 to the desired position. Lever 38 extends through air channel 24 and is fixedly attached to inner flap 36. Inner flap 36 is moved to the opened position when the user wishes to ignite the charcoal. In the closed position, inner flap 36 completely blocks the airflow created by fan 30.

Another unique feature of the present invention is a heat vent 34 located on the upper surface of air chamber 24, between inner flap 36 and aperture 28. Heat vent 34 provides an outlet for the heat from grill body 12 when inner flap 36 is partially or completely closed.

In an exemplary embodiment of the present invention, heat vent 34 is covered by a heat vent cover 35 that is flexibly connected to the top of air chamber 24 by any means. Heat vent cover 35 helps prevent ash or other contaminants from reaching fan 30. In some embodiments of the present invention, heat vent 34 may by covered other methods, for example, a sliding panel.

In the exemplary embodiment, inner flap 36 and heat vent 34 may operate independently. In alternative embodiments, inner flap 36 and heat vent 34 may operate in tandem, wherein a single lever 38 operates both, such that when inner flap 36 is completely open, heat vent cover 35 is completely closed, when inner flap 36 is partially open, heat vent cover 35 is correspondingly partially open, and when inner flap 36 is completely closed, heat vent cover 35 is completely open. Yet other embodiments may allow for inner flap 36 and heat vent 34 to operate in other configurations.

A power cable 42 extends out from fan 30 and leads to a power source in order to provide power to fan 30. In one embodiment, fan 30 may be powered by a replaceable battery. In other embodiments, the power may originate from other sources, including, for example, a car battery, an electrical wall outlet, or solar power. A power switch 44 of any kind allows the user to activate or turn off fan 30. The rotation of the fan can be controlled.

Cooking grid 48 provides a cooking surface on which food can be placed. An added feature of the present invention is that the entire area of cooking grid 48 may be used, without having to leave gaps for air circulation, because air is provided by fan 30 from underneath cooking grid 48.

A charcoal plate 50 equipped with a plurality of grid-like openings, is situated inside grill body 12 and below cooking grid 48. Charcoal plate 50 holds the charcoal required for cooking and creates a partitioned area to separate the airflow area from the charcoal.

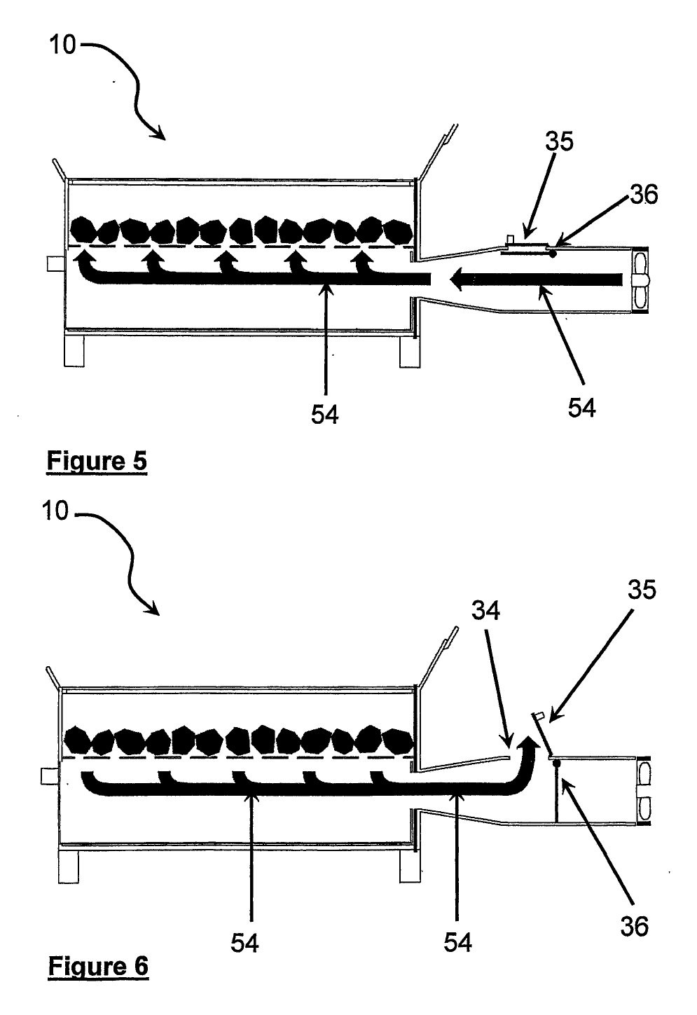

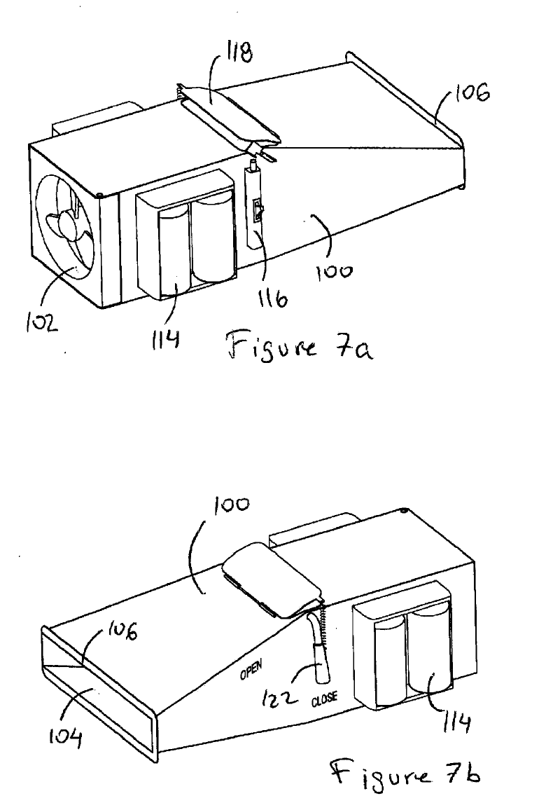

FIGS. 5 and 6 describe the airflow created by fan 30, wherein the heavy arrows represent the direction of the airflow 54 through grill 10.

During the ignition phase, shown in FIG. 5, heat vent cover 35 is closed, and inner flap 36 is open. The charcoal is ignited in any suitable manner, and power switch 44 is moved to the “ON” position. When fan 30 is activated, ambient air is drawn in by fan 30. The increased airflow created by fan 30 causes air to flow along air chamber 24, through apertures 28 into grill body 12. Once within grill body 12, the air flows up and out through the plurality of openings in charcoal plate 50, circulating air through the charcoal, and causing the charcoal to quickly reach a suitable cooking temperature.

Shown in FIG. 6 is an exemplary configuration of heat vent 34, heat vent cover 35, and inner flap 36 during the cooking phase, wherein the charcoal has reached cooking temperature. During this phase, heat vent cover 35 is opened and inner flap 36 is closed. The user may alternatively regulate the airflow by, for example, turning off fan 30. In alternative embodiments, fan 30 may be equipped with a variable speed option. Heat vent 34 is provided to allow heat to escape from body 12 when fan 30 is not in use, without damaging fan 30.

There is the option of adding openings 58 to grill body 12 or ash catcher 20 or both in order to allow the flames to be viewed. An example of an embodiment with such an option is seen in FIG. 1.

While the exemplary embodiment of the present invention is of a portable size, there is also the option of manufacturing the present invention in other sizes. Additionally, the present invention may or may not include a cover that is flexibly attached to grill body 12 or elsewhere on grill 10, or is completely removable.

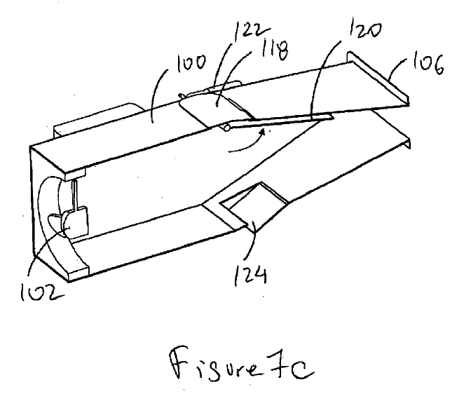

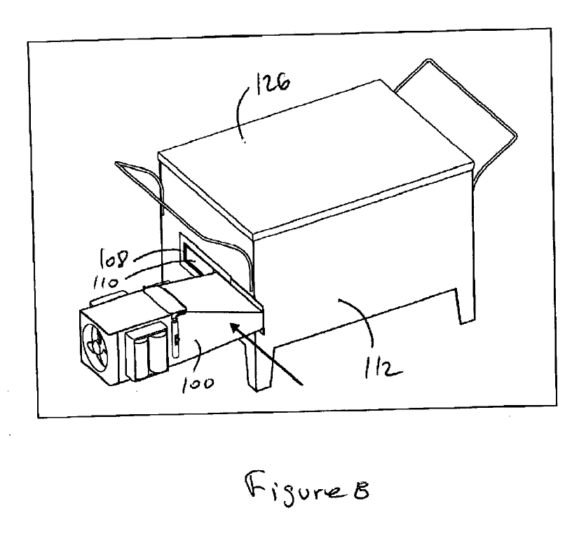

FIGS. 7a, b and c illustrate two isometric views of an add-on air chamber in accordance with a preferred embodiment of the present invention as well as a cross sectional view of the air chamber. Air chamber 100 provided with a fan 102 can be incorporated onto a grill in an add-on manner wherein the chamber 100 is provided with an opening 104 having lips 106 that are slidably inserted through a corresponding receiver 108 surrounding a corresponding opening 110 in grill 112 as shown in FIG. 8. FIG. 8 illustrates a grill partially installed with the add-on air chamber 100.

Basically, in the exemplary embodiment of the present invention, air chamber 100 is provided with similar features as the air chamber shown herein above in the other exemplary embodiments. In order to complete the portability feature of the grill, batteries 114 can be provided to the air chamber body wherein the batteries are activating fan 102 through switch 114. Fan 102 can be connected to the air chamber through a hinge in a manner shown herein above.

Similarly to the above mentioned exemplary embodiment, air chamber 100 is provided with an outer flap 118 and an inner flap 120 that are movable using a lever 122 as shown herein before.

A bottom opening 124 is also provided in air chamber 100 so as to allow liquids from the cooking process or other liquids that may enter the air chamber to drain.

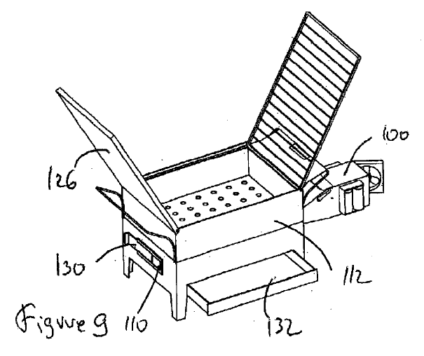

FIG. 9 illustrates a grill provided with the add-on air chamber in accordance with another preferred embodiment of the present invention. Grill 112 that is shown in FIG. 8 is provided with a cover 126 for covering the grill when it is not in use. In the exemplary embodiment, Grill 112 is provided with two openings 110 in both sides of the grill so as to allow the air chamber to be connected in one of the sides. When the opening is not used, a closure 130 is provided so as to block the opening that is not in use.

Optionally, a drawer 132 is provided in the bottom portion of grill 112 so as to allow cooked materials to be kept warm.

The fan can be operated in various ways such as mechanical or electrical and the means to operate the fan by no means limits the scope of the present invention.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A charcoal grill with an integrated fan, said grill comprised of:
a grill body, including a cook box, a cooking grid, and a ventilated charcoal plate;
an air chamber having a first side attached to the side of the grill body and a second side;
a fan provided in said second side, wherein when the fan is activated, airflow generated by the fan flows from beneath through the charcoal, causing the charcoal to heat quickly and efficiently by increasing the airflow to the charcoal.

2. The charcoal grill of claim 1 further comprising an insulating layer located on the side of the grill body to which the air chamber is connected.

3. The charcoal grill of claim 1, further including a heat vent on the upper part of the air chamber.

4. The charcoal grill of claim 3, further including a heat vent cover attached to the upper part of the air chamber.

5. The charcoal grill of claim 4, further comprising a handle for controlling the heat vent cover.

6. The charcoal grill of claim 1, further including an inner flap attached to the interior of the air chamber for further controlling the airflow between the grill body and the fan.

7. The charcoal grill of claim 6, further comprising a handle for controlling the inner flap.

8. The charcoal grill of claim 6 further including a heat vent on the air chamber, wherein the inner flap is further able to cover the heat vent when the inner flap is positioned horizontally.

9. The charcoal grill of claim 1, wherein a draining opening is provided in a bottom side of said air chamber.

10. The charcoal grill of claim 1, wherein a drawer is provided in a bottom portion of said cook box wherein said drawer is moving between an open position and a closed position.

11. The charcoal grill of claim 1, wherein said fan is electrically operated.

12. A charcoal grill with an add-on fan, said grill comprised of:
a grill body including a cook box provided with a first opening, a cooking grid, and a ventilated charcoal plate;
an air chamber having a second opening designed to fit onto said first opening so as to be connected to a side of the grill body;
a fan provided in said air chamber, wherein when the fan is activated, the airflow generated by the fan flows beneath and through the charcoal, causing the charcoal to heat quickly and efficiently by increasing the airflow to the charcoal.

13. The charcoal grill of claim 12 wherein said air chamber is slidably connected to said grill body.

14. The charcoal grill of claim 12, further including a heat vent on the upper part of the air chamber.

15. The charcoal grill of claim 14, further including a heat vent cover attached to the upper part of the air chamber.

16. The charcoal grill of claim 15, further comprising a handle for controlling the heat vent cover.

17. The charcoal grill of claim 12, further including an inner flap attached to the interior of the air chamber for further controlling the airflow between the grill body and the fan.

18. The charcoal grill of claim 17, further comprising a handle for controlling the inner flap.

19. The charcoal grill of claim 17 further including a heat vent on the air chamber, wherein the inner flap is further able to cover the heat vent when the inner flap is positioned horizontally.

20. The charcoal grill of claim 12, wherein a draining opening is provided in a bottom side of said air chamber.

21. The charcoal grill of claim 12, wherein a drawer is provided in a bottom portion of said cook box wherein said drawer is moving between an open position and a closed position.

22. The charcoal grill of claim 12, wherein said cook box is further provided with an additional opening on another side of the cook box and wherein a closure is provided to said opening.

23. The charcoal grill of claim 12, wherein said fan is connected to said air chamber through a hinge.

24. The charcoal grill of claim 12, wherein said fan is electrically operated.

25. The charcoal grill of claim 12, wherein a power source is provided to said air chamber.

26. The charcoal grill of claim 24, wherein said power source are batteries and wherein a switch is provided capable of electrically disconnecting said batteries from said fan and vice versa and controlling fan rotation speed.
